(19) United States
(12) Patent Application Publication
(10) Pub. No.: US 2017/0292355 A1
(43) Pub. Date: Oct. 12, 2017

(54) PROCESS OF RECOVERING OIL

(71) Applicant: SHELL OIL COMPANY, Houston, TX (US)

(72) Inventors: Diederik Willem VAN BATENBURG, Rijswijk (NL); Diederik Michiel BOERSMA, Rijswijk (NL); Sjaamkisoor OEDAI, Rijswijk (NL); Evren UNSAL, Rijswijk (NL); Johannes Nicolaas Maria VAN WUNNIK, Rijswijk (NL)

(21) Appl. No.: 15/480,997

(22) Filed: Apr. 6, 2017

Related U.S. Application Data
(60) Provisional application No. 62/320,977, filed on Apr. 11, 2016.

(51) Int. Cl. E21B 43/16; C09K 8/584

(52) U.S. Cl. CPC E21B 43/16; C09K 8/584

(57) ABSTRACT

A process of recovering oil from an oil-bearing formation which process comprises injecting a surfactant containing enhanced oil recovery formulation into the formation via an injection well and recovering oil and optionally gas via a recovery well which process comprises determining the apparent viscosity of the enhanced oil recovery formulation at various ratios of enhanced oil recovery formulation to oil wherein the highest apparent viscosity is at most 4 times the lowest apparent viscosity measured.

This application claims the benefit of U.S. Provisional Application No. 62/320,977 filed Apr. 11, 2016, the entire disclosure of which is hereby incorporated by reference.

### FIELD OF THE INVENTION

The present invention relates to a process of recovering oil from an oil-bearing formation.

### BACKGROUND OF THE INVENTION

In the recovery of oil from a subterranean formation, only a portion of the oil in the formation generally is recovered using primary recovery methods utilizing the natural formation pressure to produce the oil. A portion of the oil that cannot be produced from the formation using primary recovery methods may be produced by chemical enhanced oil recovery, also referred to as improved oil recovery or EOR.

Enhanced oil recovery can utilize aqueous solutions comprising surfactant or a combination of surfactant and polymer to flood an oil-bearing formation to increase the amount of oil recovered from the formation. An aqueous dispersion of a surfactant and optionally a polymer is injected into an oil-bearing formation to increase recovery of oil from the formation, either after primary recovery or after a secondary recovery water flood. Without wishing to be bound by any theory, it is thought that the surfactant enhances recovery of oil from the formation by lowering interfacial tension between oil and water phases in the formation thereby mobilizing the oil for production. If polymer is present, this is thought to increase the viscosity of the enhanced oil recovery formulation, preferably to the same order of magnitude as the oil in the formation in order to force the mobilized oil through the formation for production by the polymer containing flood.

Many enhanced oil recovery formulations have been developed and tested. Success of an enhanced oil recovery formulation depends on its ability to provide sweep and displacement efficiency during oil recovery. Therefore, the formulation tends to be tested for each field and optimized in such a way that an optimum phase behavior is generated. Specific attention is given to microemulsions which can form in situ during surfactant flooding. The rheology of microemulsions can be very unpredictable regardless of how low the interfacial tension is. High viscosity may impair the recovery process by plugging the pore space and has been identified as the reason for failure in recovery systems.

Whether a specific oil recovery formulation is suitable for a specific formation can be established by premixing the enhanced oil recovery formulation in various ratios with the oil present in the formation and studying the rheology of the microemulsion during steady state flow through a core taken from the oil-bearing formation.

### SUMMARY OF THE INVENTION

It will be clear that the above method for qualifying an enhanced oil recovery formulation is cumbersome. Surprisingly, it now has been found that for enhanced oil recovery formulations comprising surfactant, the apparent viscosity of mixtures of oil and such formulations did not depend on the permeability of the core.

It will be clear that the above method for qualifying an enhanced oil recovery formulation is cumbersome. Surprisingly, it now has been found that for enhanced oil recovery formulations comprising surfactant, the apparent viscosity of mixtures of oil and such formulations did not depend on the permeability of the core. This finding makes it possible to decide whether a formulation is suitable for enhanced oil recovery for a specific formation and oil without having to carry out a large number of laboratory experiments using cores matching the formation in question as is currently required.

The process of the present invention relates to a process of recovering oil from an oil-bearing formation which process comprises injecting a surfactant containing enhanced oil recovery formulation into the formation via an injection well and recovering oil and optionally gas via a recovery well which process comprises determining the apparent viscosity of the enhanced oil recovery formulation at various ratios of enhanced oil recovery formulation to oil wherein the highest apparent viscosity is at most 4 times the lowest apparent viscosity measured.

### DETAILED DESCRIPTION OF THE INVENTION

The apparent viscosity is determined as recommended by the American Petroleum Institute, Recommended Practices for Core Analysis, Recommended Practice 40, Second Edition, February 1998 for Vertical Flow of Liquids (item 6.6.6.1.2).

The apparent viscosity is defined as follows:

$$μ = \frac{K {C}_{1} A Δ p}{L {C}_{2} q} \qquad ( 1 )$$

where k is the permeability of the medium, A is the cross-sectional area perpendicular to the line of flow, Δp is the pressure gradient, L is the height of the sample, q is the volume rate of flow, and C₁ and C₂ are constants that make the units consistent. As we found that the permeability of the core can be disregarded for surfactant containing enhanced oil recovery formulations while C₁ and C₂ are constants, it suffices to assess the pressure gradient for a given q such as 0.25 ml/min for various oil to enhanced oil recovery formulations. The pressure gradient generally first is measured for a composition of known apparent viscosity in order to determine the value for k. After this, the apparent viscosities for other mixtures can be calculated based on the known values and the measured pressure gradient.

It will be clear to the person skilled in the art that the most trustworthy prediction of the suitability of an enhanced oil recovery formulation is obtained by assessing the apparent viscosity for a large number of ratios. However, it is preferred to limit the number of measurements from a cost and from an efficiency point of view. Generally, the number of measurements will be of from 5 to 20. Preferably, the pressure gradient is measured at those ratios of oil to enhanced oil recovery formulation where the highest and the lowest value for the apparent viscosity is expected. A low value is generally expected for the enhanced oil recovery formulation per se so in the absence or substantial absence of oil.

Another low value can be expected for the oil per se so in the absence or in the substantial absence of the enhanced oil recovery formulation. A high value can be expected when a substantial amount of both oil and enhanced oil recovery formulation is present more preferably at a volume ratio of oil to enhanced oil recovery formulation of from 90:10 to 30:70.

Preferably, the highest apparent viscosity measured for a specific oil and specific enhanced oil recovery formulation is at most 3 times the lowest apparent viscosity measured. More preferably, the highest apparent viscosity measured for a specific oil and specific enhanced oil recovery formulation is at most 2 times the lowest apparent viscosity measured.

The highest apparent viscosity preferably is at most 3 times the apparent viscosity of the oil in the formation. More specifically, the highest apparent viscosity preferably is at most 3 times the apparent viscosity of the enhanced oil recovery formulation.

The enhanced oil recovery formulation of the present invention generally will contain water and surfactant.

The expression water is used to indicate any source of water including but not limited to fresh water generally containing traces of contaminants up to sea water and brine containing substantial amounts of such contaminants.

If pure water is used, the formulation consists of water, polymer and alkali. Pure water is considered to be water having a total dissolved solids content (TDS, measured according to ASTM D5907) of at most 4000 ppm, more specifically at most 3000 ppm, more specifically at most 2000 ppm, most specifically at most 1000 ppm. The expression “ppm” indicates parts per million by weight on total weight amount present.

Water sources other than pure water are sea water, brackish water, aquifer water, formation water and brine. Sources other than fresh water generally have a TDS of more than 1,000 ppm, more specifically at least 2,000 ppm, more specifically at least 3,000 ppm, more specifically at least 4,000 ppm, more specifically at least 5,000 ppm, most specifically at least 10,000 ppm. Most water sources have a TDS of less than 100,000 ppm, more specifically less than 80,000 ppm, more specifically at most 60,000 ppm, most specifically at most 40,000 ppm. These amounts are before alkali and polymer and optionally surfactant have been added.

It is especially advantageous if the water used for preparing the formulation contains a limited amount of divalent ions such as less than 4000 ppm, more specifically less than 2000 ppm, more specifically less than 1000 ppm, more specifically at most 500 ppm, more specifically at most 100 ppm, most specifically at most 20 ppm of divalent ions based on total amount of water. More specifically, these amounts relate to the calcium and/or magnesium containing salts.

The oil recovery formulation further comprises a surfactant. The surfactant may be any surfactant effective to reduce the interfacial tension between oil and water in the oil-bearing formation and thereby mobilize the oil for production from the formation. The oil recovery formulation may comprise one or more surfactants. The surfactant may be an anionic surfactant. The anionic surfactant may be a sulfonate-containing compound, a sulfate-containing compound, a carboxylate compound, a phosphate compound, or a blend thereof. The anionic surfactant may be an alpha olefin sulfonate compound, an internal olefin sulfonate compound, a branched alkyl benzene sulfonate compound, a propylene oxide sulfate compound, an ethylene oxide sulfate compound, a propylene oxide-ethylene oxide sulfate compound, or a blend thereof.

The anionic surfactant preferably contains from 12 to 28 carbons, or from 12 to 20 carbons. The surfactant of the oil recovery formulation may comprise an internal olefin sulfonate compound containing from 15 to 18 carbons or a propylene oxide sulfate compound containing from 12 to 15 carbons, or a blend thereof, where the blend contains a volume ratio of the propylene oxide sulfate to the internal olefin sulfonate compound of from 1:1 to 10:1.

The oil recovery formulation may contain an amount of the surfactant effective to reduce the interfacial tension between oil and water in the formation and thereby mobilize the oil for production from the formation. The oil recovery formulation may contain from 0.05 wt. % to 5 wt. % of the surfactant or combination of surfactants, or may contain from 0.1 wt. % to 3 wt. % of the surfactant or combination of surfactants based on total amount of formulation.

In a preferred embodiment, the formulation is prepared by adding a mixture of alkali and polymer, more preferably a solid mixture of alkali and polymer. The mixtures are easy to handle and store while they still give a formulation having improved filterability properties.

The formulation can further contain polymer. Polymer generally is intended to provide the formulation with a viscosity of the same order of magnitude as the viscosity of oil in the formation under formation temperature conditions so the oil recovery formulation may drive mobilized oil across the formation for production from the formation with a minimum of fingering of the oil through the oil recovery formulation and/or fingering of the oil recovery formulation through the oil. The polymer can be a single compound or can be a mixture of compounds. Preferably, the polymer is selected from the group consisting of polyacrylamide; partially hydrolyzed polyacrylamide; polyacrylate; ethylenic co-polymer; carboxymethylcelloluse; polyvinyl alcohol; polystyrene sulfonate; polyvinylpyrrolidone; biopolymers; 2-acrylamide-methyl propane sulfonate (AMPS); styrene-acrylate copolymer; co-polymers of acrylamide, acrylic acid, AMPS and n-vinylpyrrolidone in any ratio; and combinations thereof.

Examples of ethylenic co-polymers include co-polymers of acrylic acid and acrylamide, acrylic acid and lauryl acrylate, and lauryl acrylate and acrylamide. Examples of biopolymers include xanthan gum, guar gum, schizophyllan and scleroglucan.

Most preferably, the polymer is (hydrolyzed) polyacrylamide. The latter includes but is not limited to copolymers of acrylamide and acrylic acid or sodium acrylate such as polymers which are being sold by SNF under the name Flopaam 3630S, Flopaam 6030S and Flopaam EM533.

The concentration of the polymer in the oil recovery formulation to be injected into the formation preferably is sufficient to provide the oil recovery formulation with a dynamic viscosity of at least 0.3 mPa s (0.3 cP), more specifically at least 1 mPa s (1 cP), or at least 10 mPa s (10 cP), or at least 100 mPa s (100 cP), or at least 1000 mPa s (1000 cP) at 25° C. or at a temperature within a formation temperature range. The concentration of polymer in the oil recovery formulation preferably is from 250 ppm to 10000 ppm, or from 500 ppm to 5000 ppm, or from 1000 to 2000 ppm based on total amount of formulation.

The molecular weight number average of the polymer in the oil recovery formulation preferably is at least 10000 daltons, or at least 50000 daltons, or at least 100000 daltons. The polymer preferably has a molecular weight number average of from 10000 to 30000000 daltons, or from 100000 to 15000000 daltons.

The oil recovery formulation may also comprise co-solvent with water, where the co-solvent may be a low molecular weight alcohol including, but not limited to, methanol, ethanol, and iso-propanol, isobutyl alcohol, secondary butyl alcohol, n-butyl alcohol, t-butyl alcohol, or a glycol including, but not limited to, ethylene glycol, 1,3-propanediol, 1,2-propandiol, diethylene glycol butyl ether, triethylene glycol butyl ether, or a sulfosuccinate including, but not limited to, sodium dihexyl sulfosuccinate. The co-solvent may be utilized for assisting in prevention of formation of a viscous emulsion. If present, the co-solvent preferably is present in an amount of from 100 ppm to 50000 ppm, or from 500 ppm to 5000 ppm of the total oil recovery formulation. A co-solvent may be absent from the oil recovery formulation.

The oil recovery formulation may additionally contain paraffin inhibitor to inhibit the formation of a viscous paraffin-containing emulsion in the mobilized oil by inhibiting the agglomeration of paraffins in the oil. The mobilized oil, therefore, may flow more freely through the formation for production relative to mobilized oil in which paraffins enhance the formation of viscous emulsions. The paraffin inhibitor of the oil recovery formulation may be a compound effective to inhibit or suppress formation of a paraffin-containing emulsion. The paraffin inhibitor may be a compound effective to inhibit or suppress agglomeration of paraffins to inhibit or suppress paraffinic wax crystal growth in the oil of the formation upon contact of the oil recovery formulation with the oil in the formation. The paraffin inhibitor may be any commercially available conventional crude oil pour point depressant or flow improver that is dispersible, and preferably soluble, in the fluid of the oil recovery formulation in the presence of the other components of the oil recovery formulation, and that is effective to inhibit or suppress formation of a paraffin-nucleated emulsion in the oil of the formation. The paraffin inhibitor may be selected from the group consisting of alkyl acrylate copolymers, alkyl methacrylate copolymers, alkyl acrylate vinylpyridine copolymers, ethylene vinylacetate copolymers, maleic anhydride ester copolymers, styrene anhydride ester copolymers, branched polyethylenes, and combinations thereof.

Commercially available paraffin inhibitors that may be used in the oil recovery formulation include HiTEC 5714, HiTEC 5788, and HiTEC 672 available from Afton Chemical Corp; FLOTRON D1330 available from Champion Technologies; and INFINEUM V300 series available from Infineum International.

The paraffin inhibitor may be present in the oil recovery formulation in an amount of from 5 ppm to 5000 ppm, or from 10 ppm to 1000 ppm, or from 15 ppm to 500 ppm, or from 20 ppm to 300 ppm based on total amount of formulation.

The enhanced oil recovery formulation can further contain alkali. Alkali may not only aid in dissolving the polymer but may also interact with oil in the formation to form a soap effective to reduce the interfacial tension between oil and water in the formation. The alkali added for this purpose can be incorporated in the formulation before or after or simultaneous with the polymer and preferably is selected from the group consisting of ammonia, lithium hydroxide, sodium hydroxide, potassium hydroxide, lithium carbonate, sodium carbonate, potassium carbonate, lithium bicarbonate, sodium bicarbonate, potassium bicarbonate, lithium silicate, sodium silicate, potassium silicate, lithium phosphate, sodium phosphate, potassium phosphate, and mixtures thereof. Most preferably, the alkali is ammonia.

The amount of the alkali effective to interact with the oil in the formation to form a soap effective to reduce the interfacial tension between oil and water in the formation and thereby mobilize the oil for production from the formation preferably is of from 0.001 wt. % to 5 wt. % of the alkali, or from 0.005 wt. % to 1 wt. % of the alkali, or from 0.01 wt. % to 0.5 wt. % of the alkali based on total amount of enhanced oil recovery formulation.

In a preferred method of the present invention, the oil recovery formulation is introduced into an oil-bearing formation or oil formation. The oil contained in the oil-bearing formation may have a dynamic viscosity under formation conditions (in particular, at temperatures within the temperature range of the formation) of at least 0.3 mPa s (0.3 cP), more specifically at least 1 mPa s (1 cP), or at least 10 mPa s (10 cP), or at least 100 mPa s (100 cP), or at least 1000 mPa s (1000 cP), or at least 10000 mPa s (10000 cP). The oil contained in the oil-bearing formation may have a dynamic viscosity under formation temperature conditions of from 1 to 10000000 mPa s (1 to 10000000 cP).

The following exemplifies the present invention but is not intended to limit, or define, the scope of the current invention.

### EXAMPLES

Coreflood experiments were carried out with different cores of Berea sandstones indicated as A and B. Core A had a lower permeability than Core B. The cores were mounted vertically in experimental core flooding set up. The core was flushed with carbon dioxide. A vacuum was then applied and the core was imbibed with brine until a stable pressure across the core was established.

Subsequently, a surfactant containing formulation and oil were co-injected at various fractional flow ratios. The experiments used dead crude as the oil phase. The surfactant containing formulation contained 0.4% wt of ENORDET J771, 0.1% wt ENORDET 0332, 0.5% wt 2-butanol, 2% wt Na₂CO₃ and 0.13% wt commercially available polymer. ENORDET is a trade mark of Shell Chemicals.

The core flooding was carried out at a flow ratio of 0.250 ml/min and was completed at 69° C. Before changing rates, it was ensured that the pressures were stable.

The fractional flow sequence started with a formulation comprising 50 vol % enhanced oil recovery formulation and 50 vol % of oil followed (50/50) by 30/70, 10/90, 90/10, 70/30 and a final 50/50.

The apparent viscosity was measured using equation (1). Table 1 shows the apparent viscosity of the various mixtures of surfactant containing formulation and oil.

TABLE 1

| | 10% | | | | 90% | 50% ASP |
|---|---|---|---|---|---|---|
| | ASP | 30% ASP | 50% ASP | 70% ASP | ASP | (final) |
| Core A | 2.8 | 3.4 | 3.3 | 3.8 | 4.2 | 3.3 |
| Core B | 1.6 | 2.6 | 2.8 | 3.0 | 3.1 | 2.7 |

It is clear from Table 1 that the enhanced oil recovery formulations had very similar apparent viscosity at different oil to surfactant formulation ratios and with different cores.

What is claimed is:

1. A process of recovering oil from an oil-bearing formation which process comprises injecting a surfactant containing enhanced oil recovery formulation into the formation via an injection well and recovering oil and optionally gas via a recovery well which process comprises determining the apparent viscosity of the enhanced oil recovery formulation at various ratios of enhanced oil recovery formulation to oil wherein the highest apparent viscosity is at most 4 times the lowest apparent viscosity measured.

2. A process according to claim 1, in which the highest apparent viscosity is at most 3 times the lowest apparent viscosity measured.

3. A process according to claim 1, in which the highest apparent viscosity is at most 3 times the apparent viscosity of the oil in the formation.

4. A process according to claim 1, in which the highest apparent viscosity is at most 3 times the apparent viscosity of the enhanced oil recovery formulation.

5. A process according to claim 2, in which the highest apparent viscosity is at most 2 times the lowest apparent viscosity measured.

6. A process according to claim 1, in which the enhanced oil recovery formulation further comprises polymer.

7. Process according to claim 6, in which the polymer is (hydrolyzed) polyacrylamide.

8. Process according to claim 1, which the enhanced oil recovery formulation further comprises alkali.

9. Process according to claim 8, in which the alkali is ammonia.
